(19) United States
(12) Patent Application Publication
(10) Pub. No.: US 2008/0082755 A1
(43) Pub. Date: Apr. 3, 2008

(54) Administering An Access Conflict In A Computer Memory Cache

(76) Inventors: Marcus L. Kornegay, Durham, NC (US); Ngan N. Pham, Raleigh, NC (US)

Correspondence Address: IBM (RPS-BLF);c/o BIGGERS & OHANIAN, LLP, P.O. BOX 1469, AUSTIN, TX, 78767-1469, US

(21) Appl. No.: 11/536,798

(22) Filed: Sep. 29, 2006

(51) Int. Cl. G06F 13/28

(52) U.S. Cl. 711/141

(57) ABSTRACT

Administering an access conflict in a computer memory cache, including receiving in a memory cache controller a write address and write data from a store memory instruction execution unit of a superscalar computer processor and a read address for read data from a load memory instruction execution unit of the superscalar computer processor, for the write data to be written to and the read data to be read from a same cache line in the computer memory cache simultaneously on a current clock cycle; storing by the memory cache controller the write data in the same cache line on the current clock cycle; stalling, by the memory cache controller in the load memory instruction execution unit, a corresponding load microinstruction; and reading by the memory cache controller from the computer memory cache on a subsequent clock cycle read data from the read address.

### BACKGROUND OF THE INVENTION

1. Field of the Invention

The field of the invention is data processing, or, more specifically, methods, systems, and products for administering an access conflict in a computer memory cache.

2. Description of Related Art

Computer memory caches are organized in ‘cache lines,’ segments of memory typically of the size that is used to write and read from main memory. The superscalar computer processors in contemporary usage implement multiple execution units for multiple processing pipelines executing microinstructions in microcode, thereby making possible simultaneous access by two different pipelines of execution to exactly the same memory cache line at the same time. The size of the cache lines is larger than the size of typical read and writes from a superscalar computer processor to and from memory. If, for example, a processor reads and writes memory in units of bytes, words (two bytes), double words (four bytes), and quad words (eight bytes), the processor's cache lines may be as eight bytes (32 bits) or sixteen bytes (64 bits)—so that all reads and writes between the processor and the cache will fit into one cache line. In such a system, however, a store microinstruction and a read microinstruction, neither of which accesses the same memory location, can nevertheless both access the same cache line—because the memory locations addressed, although different, are both within the same cache line. This pattern of events is referred to as an access conflict in a computer memory cache.

In a typical memory cache, the read and write electronics each require exclusive access to each cache line when writing or reading data to or from the cache line—so that a simultaneous read and write to the same cache line cannot be conducted on the same clock cycle. This means that when an access conflict exist, either the load microinstruction or the store microinstruction must be delayed or ‘stalled.’ Prior art methods of administering access conflicts allow the store microinstruction to be stalled to a subsequent clock cycle while the load microinstruction proceeds to execute as scheduled on a current clock cycle. Such a priority scheme impacts performance because subsequent stores cannot be retired before a previously stalled store microinstruction completes—because stores are always completed by processor execution units in order—and this implementation increases the probability of stalled stores. Routinely allowing stalled stores therefore risks considerable additional disruption of processing pipelines in contemporary computer processors.

### SUMMARY OF THE INVENTION

Methods and apparatus are disclosed for administering an access conflict in a computer memory cache so that a conflicting store microinstruction is always given priority over a corresponding load microinstruction—thereby eliminating the risk of stalling subsequent store microinstructions. More particularly, methods and apparatus are disclosed for administering an access conflict in a computer memory cache that include receiving in a memory cache controller a write address and write data from a store memory instruction execution unit of a superscalar computer processor and a read address for read data from a load memory instruction execution unit of the superscalar computer processor, for the write data to be written to and the read data to be read from a same cache line in the computer memory cache simultaneously on a current clock cycle; storing by the memory cache controller the write data in the same cache line on the current clock cycle; stalling, by the memory cache controller in the load memory instruction execution unit, a corresponding load microinstruction; and reading by the memory cache controller from the computer memory cache on a subsequent clock cycle read data from the read address.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of automated computing machinery comprising an example of a computer useful in administering an access conflict in a computer memory cache according to embodiments of the present invention.

FIG. 2 sets forth a functional block diagram of exemplary apparatus for administering an access conflict in a computer memory cache according to embodiments of the present invention.

FIG. 3 sets forth a functional block diagram of exemplary apparatus for administering an access conflict in a computer memory cache according to embodiments of the present invention.

FIG. 4 sets forth a flow chart illustrating an exemplary method for administering an access conflict in a computer memory cache according to embodiments of the present invention.

FIG. 5 sets forth an exemplary timing diagram that illustrates administering an access conflict in a computer memory cache according to embodiments of the present invention.

### DETAILED DESCRIPTION OF EXEMPLARY EMBODIMENTS

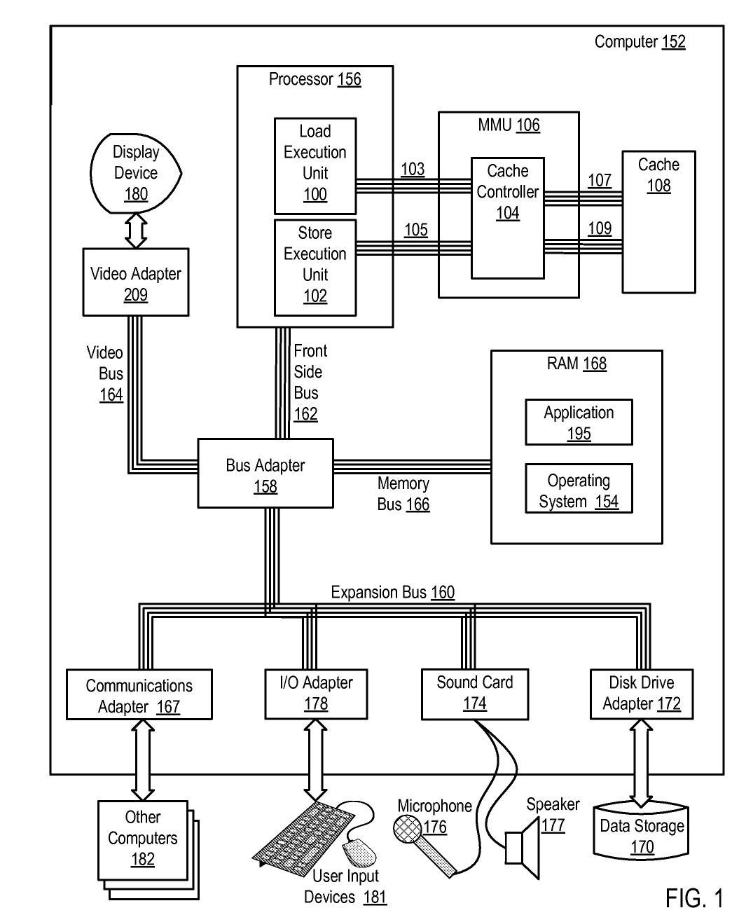

Exemplary methods, systems, and products for administering an access conflict in a computer memory cache according to embodiments of the present invention are described with reference to the accompanying drawings, beginning with FIG. 1. Administering an access conflict in a computer memory cache according to embodiments of the present invention is generally implemented with computers, that is, automated computing machinery or computers. FIG. 1 sets forth a block diagram of automated computing machinery comprising an example of a computer (152) useful in administering an access conflict in a computer memory cache according to embodiments of the present invention. The computer (152) of FIG. 1 includes at least one computer processor (156) or ‘CPU’ as well as random access memory (168) (‘RAM’) which is connected through a high speed memory bus (166), bus adapter (158), and front side bus (162) to processor (156) and to other components of the voice server.

The processor (156) is a superscalar processor that includes more than one execution unit (100, 102). A superscalar processor is a computer processor includes multiple execution units to allow the processing in multiple pipelines of more than one instruction at a time. A pipeline is a set of data processing elements connected in series within a processor, so that the output of one processing element is the input of the next one. Each element in such a series of elements is referred to as a ‘stage,’ so that pipelines are characterized by a particular number of stages, a three-stage pipeline, a four-stage pipeline, and so on. All pipelines have at least two stages, and some pipelines have more than a dozen stages. The processing elements that make up the stages of a pipeline are the logical circuits that implement the various stages of an instruction (address decoding and arithmetic, register fetching, cache lookup, and so on). Implementation of a pipeline allows a processor to operate more efficiently because a computer program instruction can execute simultaneously with other computer program instructions, one in each stage of the pipeline at the same time.

Thus a five-stage pipeline can have five computer program instructions executing in the pipeline at the same time, one being fetched from a register, one being decoded, one in execution in an execution unit, one retrieving additional required data from memory, and one having its results written back to a register, all at the same time on the same clock cycle.

The superscalar processor (156) is driver by a clock (not shown). The processor is made up of internal networks of static and dynamic logic: gates, latches, flip flops, and registers. When the clock arrives, dynamic elements (latches, flip flops, and registers) take their new value and the static logic then requires a period of time to decode the new values. Then the next clock pulse arrives and the dynamic elements again take their new values, and so on. By breaking the static logic into smaller pieces and inserting dynamic elements between the pieces of static logic, the delay before the logic gives valid outputs is reduced, which means that the clock period can be reduced—and the processor can run faster.

The superscalar processor (156) can be viewed as providing a form of “internal multiprocessing,” because multiple execution units can operate in parallel inside the processor on more than one instruction at the same time. Many modern processors are superscalar; some have more parallel execution units than others. An execution unit is a module of static and dynamic logic within the processor that is capable of executing a particular class of instructions, memory I/O, integer arithmetic, Boolean logical operations, floating point arithmetic, and so on. In a superscalar processor, there is more than one execution unit of the same type, along with additional circuitry to dispatch instructions to the execution units. For instance, most superscalar designs include more than one integer arithmetic/logic unit (‘ALU’). The dispatcher reads instructions from memory and decides which ones can be run in parallel, dispatching them to the two units.

The computer of FIG. 1 also includes a computer memory cache (108) of the kind sometimes referred to as a processor cache or level-one cache, but which is referred to in this specification as a ‘computer memory cache,’ or sometimes simply as ‘a cache.’ A computer memory cache is a cache used by the processor (156) to reduce the average time for accessing memory. By contrast with the main memory in RAM (168), the cache is a smaller, faster memory which stores copies of the data from the most frequently used main memory locations—which are referred to here as ‘memory pages.’ A memory page stored in the cache is referred to as a ‘frame.’ As long as most memory accesses are to cached memory locations, the average latency of memory accesses will be closer to the cache latency than to the latency of main memory.

Main memory is organized in ‘pages.’ A cache frame is a portion of cache memory sized to accommodate a memory page. Each cache frame is further organized into memory segments each of which is called a ‘cache line.’ Cache lines may vary in size, for example, from 8 to 516 bytes. The size of the cache line typically is designed to be larger than the size of the usual access requested by a program instruction, which ranges from 1 to 16 bytes, a byte, a word, a double word, and so on.

The computer in the example of FIG. 1 includes a memory management unit (‘MMU’) (106), which in turn includes a cache controller (104). For ease of explanation, the MMU (106) and the cache (108) are shown as separate functional units external to the processor (156). Readers of skill in the art will recognize, however, that the MMU as well as the cache could be integrated within the processor itself. The MMU (106) operates generally to access memory on behalf of the processor (156). The MMU uses a high-speed translation lookaside buffer or a (slower) memory map to determine whether the contents of a memory address sought by the processor is in the cache. If the contents of the targeted address are in the cache, the MMU accesses it quickly on behalf of the processor to read or write data to or from the cache. If the contents of the targeted address are not in the cache, the MMU stalls operations in the processor for long enough to retrieve the contents of the targeted address from main memory.

The actual stores and loads of data to and from the cache are carried out by the cache controller (104). In this example, the cache controller (104) has separate interconnections (103, 105) respectively to a load memory instruction execution unit (100) and a store memory instruction execution unit (102), and the cache controller (104) is capable of accepting simultaneously from the execution units in the processor (156) both a store instruction and a load instruction at the same time. The cache controller (104) also has separate interconnections (107, 109) with the computer memory cache (108) for loading and storing data in the cache, and the cache controller (104) is capable of simultaneously, on the same clock cycle, both storing data in the cache and loading data from the cache—so long as the data to be loaded and the data to be stored are in separate cache lines within the cache.

In the example of FIG. 1, the memory cache controller (104) can receive through interconnection (105) from the store memory instruction execution unit (102) of the superscalar processor (156) a write address and write data, and the memory cache controller (104) can receive through interconnection (103) from the load memory instruction execution unit (100) of the superscalar computer processor (156) a read address for read data. The write data are intended to be written to and the read data are intended to be read from a same cache line in the computer memory cache simultaneously on a current clock cycle, thus effecting an access conflict. The cache memory controller is capable of reading read data and writing write data simultaneously on a current clock cycle—so long as the read and the write are not to the same cache line. So the read and write directed to the same cache line at the same time represents an access conflict.

If, as here where there is an access conflict, the read and the write are directed to the same cache line at the same time, the memory cache controller will stall a processor operation of some kind in order to allow either the read or the write to occur on a subsequent clock cycle. In this example, the memory cache controller (104) is configured to store the write data in the same cache line on the current clock cycle; stall the corresponding load microinstruction in the load memory instruction execution unit (100); and read the read data from the read address in the computer memory cache (108) on a subsequent clock cycle. The corresponding load microinstruction is ‘corresponding’ in the sense that it is the load microinstruction that caused the read address to be presented to the cache memory controller at the same time as the write address directed to the same cache line.

In the example computer of FIG. 1, an application program (195) is stored in RAM (168). The application program (195) may be any user-level module of computer program instructions, including, for example, a word processor application, a spreadsheet application, a database management application, a data communications application program, and so on. Also stored in RAM (168) is an operating system (154). Operating systems useful in computers that administer an access conflict in a computer memory cache according to embodiments of the present invention include UNIX™, Linux™, Microsoft NT™, AIX™, IBM's i5/OS™, and others as will occur to those of skill in the art. Operating system (154) and application program (195) in the example of FIG. 1 are shown in RAM (168), but many components of such software typically are stored in non-volatile memory also, for example, on a disk drive (170).

Computer (152) of FIG. 1 includes bus adapter (158), a computer hardware component that contains drive electronics for high speed buses, the front side bus (162), the video bus (164), and the memory bus (166), as well as drive electronics for the slower expansion bus (160). Examples of bus adapters useful in voice servers according to embodiments of the present invention include the Intel Northbridge™, the Intel Memory Controller Hub™, the Intel Southbridge™, and the Intel I/O Controller Hub™. Examples of expansion buses useful in voice servers according to embodiments of the present invention include Industry Standard Architecture (‘ISA’) buses and Peripheral Component Interconnect (‘PCI’) buses.

Computer (152) of FIG. 1 includes disk drive adapter (172) coupled through expansion bus (160) and bus adapter (158) to processor (156) and other components of the computer (152). Disk drive adapter (172) connects non-volatile data storage to the computer (152) in the form of disk drive (170). Disk drive adapters useful in voice servers include Integrated Drive Electronics (‘IDE’) adapters, Small Computer System Interface (‘SCSI’) adapters, and others as will occur to those of skill in the art. In addition, non-volatile computer memory may be implemented for a voice server as an optical disk drive, electrically erasable programmable read-only memory (so-called ‘EEPROM’ or ‘Flash’ memory), RAM drives, and so on, as will occur to those of skill in the art.

The example voice server of FIG. 1 includes one or more input/output (‘I/O’) adapters (178). I/O adapters in voice servers implement user-oriented input/output through, for example, software drivers and computer hardware for controlling output to display devices such as computer display screens, as well as user input from user input devices (181) such as keyboards and mice. The example voice server of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary computer (152) of FIG. 1 includes a communications adapter (167) for data communications with other computers (182). Such data communications may be carried out serially through RS-232 connections, through external buses such as a Universal Serial Bus (‘USB’), through data communications data communications networks such as IP data communications networks, and in other ways as will occur to those of skill in the art. Communications adapters implement the hardware level of data communications through which one computer sends data communications to another computer, directly or through a data communications network. Examples of communications adapters useful for administering an access conflict in a computer memory cache according to embodiments of the present invention include modems for wired dial-up communications, Ethernet (IEEE 802.3) adapters for wired data communications network communications, and 802.11 adapters for wireless data communications network communications.

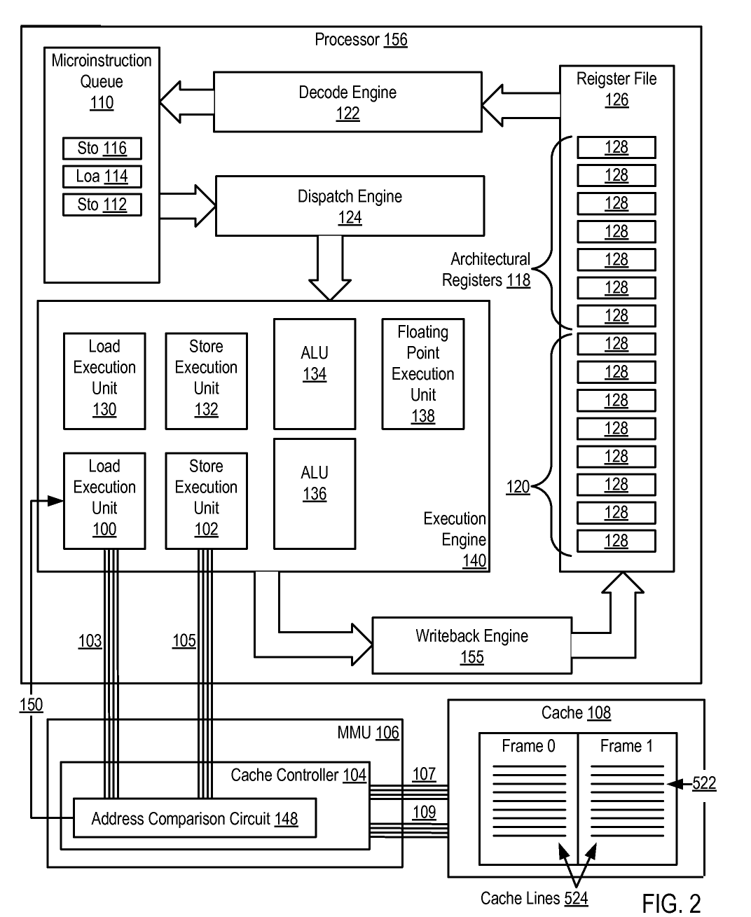

The example multimodal device of FIG. 1 also includes a sound card (174), which is an example of an I/O adapter specially designed for accepting analog audio signals from a microphone (176) and converting the audio analog signals to digital form for further processing. The sound card (174) is connected to processor (156) through expansion bus (160), bus adapter (158), and front side bus (162). For further explanation, FIG. 2 sets forth a functional block diagram of exemplary apparatus for administering an access conflict in a computer memory cache according to embodiments of the present invention. The example apparatus of FIG. 2 includes a superscalar computer processor (156), an MMU (106) with a memory cache controller (104), and a computer memory cache (108). The processor (156) includes a register file (126) made up of all the registers (128) of the processor. The register file (126) is an array of processor registers typically implemented with fast static memory devices. The registers include registers (120) that are accessible only by the execution units as well as ‘architectural registers’ (118). The instruction set architecture of processor (156) defines a set of registers, called ‘architectural registers,’ that are used to stage data between memory and the execution units in the processor. The architectural registers are the registers that are accessible directly by user-level computer program instructions. In simpler processors, these architectural registers correspond one-for-one to the entries in a physical register file within the processor. More complicated processors, such as the processor (156) illustrated here, use register renaming, so that the mapping of which physical entry stores a particular architectural register changes dynamically during execution.

The processor (156) includes a decode engine (122), a dispatch engine (124), an execution engine (140), and a writeback engine (155). Each of these engines is a network of static and dynamic logic within the processor (156) that carries out particular functions for pipelining program instructions internally within the processor. The decode engine (122) retrieves machine code instructions from registers in the register set and decodes the machine instructions into microinstructions. The dispatch engine (124) dispatches microinstructions to execution units in the execution engine. Execution units in the execution engine (140) execute microinstructions. And the writeback engine (155) writes the results of execution back into the correct registers in the register file (126).

The processor (156) includes a decode engine (122) that reads a user-level computer program instruction and decodes that instruction into one or more microinstructions for insertion into a microinstruction queue (110). Just as a single high level language instruction is compiled and assembled to a series of machine instructions (load, store, shift, etc), each machine instruction is in turn implemented by a series of microinstructions. Such a series of microinstructions is sometimes called a ‘microprogram’ or ‘microcode. ’ The microinstructions are sometimes referred to as ‘micro-operations,’ ‘micro-ops,’ or ‘μ ops’—although in this specification, a microinstruction is usually referred to as a ‘microinstruction.’

Microprograms are carefully designed and optimized for the fastest possible execution, since a slow microprogram would yield a slow machine instruction which would in turn cause all programs using that instruction to be slow. Microinstructions, for example, may specify such fundamental operations as the following:
Connect Register 1 to the “A” side of the ALU
Connect Register 7 to the “B” side of the ALU
Set the ALU to perform two's-complement addition
Set the ALU's carry input to zero
Store the result value in Register 8
Update the “condition codes” with the ALU status flags (“Negative”, “Zero”, “Overflow”, and “Carry”)
Microjump to MicroPC nnn for the next microinstruction

For a further example: A typical assembly language instruction to add two numbers, such as, for example, ADD A, B, C, may add the values found in memory locations A and B and then put the result in memory location C. In processor (156), the decode engine (122) may break this user-level instruction into a series of microinstructions similar to:
LOAD A, Reg1
LOAD B, Reg2
ADD Reg1, Reg2, Reg3
STORE Reg3, C

It is these microinstructions that are then placed in the microinstruction queue (110) to be dispatched to execution units.

Processor (156) also includes a dispatch engine (124) that carries out the work of dispatching individual microinstructions from the microinstruction queue to execution units. The processor (156) includes an execution engine that in turn includes several execution units, two load memory instruction execution units (130, 100), two store memory instruction execution units (132, 102), two ALUs (134, 136), and a floating point execution unit (138). The microinstruction queue in this example includes a first store microinstruction (112), a corresponding load microinstruction (114), and a second store microinstruction (116). The load instruction (114) is said to correspond to the first store instruction (112) because the dispatch engine (124) dispatches both the first store instruction (112) and its corresponding load instruction (114) into the execution engine (140) at the same time, on the same clock cycle. The dispatch engine can do so because the execution engine support two pipelines of execution, so that two microinstruction can move through the execution portion of the pipelines at exactly the same time.

In this example, the dispatch engine (124) detects no dependency between the first store microinstruction (112) and the corresponding load microinstruction (114), despite the fact that both instructions address memory in the same cache line, because the memory locations addressed are not the same. The memory addresses are in the same cache line, but that fact is unknown to the dispatch engine (124). As far as the dispatch engine is concerned, the load microinstruction (114) is to read data from a memory address that is different from the memory address to which the first store instruction (112) is to write data. From the point of view of the dispatch engine, therefore, there is no reason not to allow the first store microinstruction and the corresponding load microinstruction to execute at the same time. From the point of view of the dispatch engine, there is no reason to require the load microinstruction to wait for completion of the first store microinstruction.

The example apparatus of FIG. 2 also includes an MMU (106) which in turn include a memory cache controller (104) which is coupled for control and data communications with a computer memory cache (108). The computer memory cache (108) is a two-way, set associative memory cache capable of storing in cache frames two pages of memory where any page of memory can be stored in either frame. Each frame of cache (108) is further organized into cache lines (524) of cache memory where each cache line includes more than one byte of memory. For example, each cache line may include 32 bits or 64 bits—and so on.

In this example, the memory cache (108) is shown with only two frames: frame 0 and frame 1. The use of two frames in this example is only for ease of explanation. As a practical matter, such a memory cache may include any number of associative frame ways as may occur to those of skill in the art. In apparatus where the computer memory cache is configured as a set associative cache memory having a capacity of more than one frame of memory, then the fact that write data is to be written to and read data to be read from a same cache line in the computer memory cache means that the write data are to be written to and the read data are to be read from the same cache line in the same frame in the computer memory cache.

In the example of FIG. 2, the cache controller (104) includes an address comparison circuit (148) that has a stall output (150) connected to the load memory instruction execution unit for stalling the corresponding load microinstruction (114). The first store microinstruction (112) and the corresponding load microinstruction (114), dispatched to execution units for simultaneous execution, both provide memory addresses to the cache controller (104), and therefore also to the address comparison circuit (148) at the same time through interconnections (103, 105). The first store microinstruction provides a write address in computer memory where the write address has contents that are cached in the same cache line in the computer memory cache—that is, in the same cache line (522) to be accessed by the corresponding load microinstruction (114). The corresponding load microinstruction provides a read address in computer memory where the read address has content that also are cached in the same cache line (522) in the computer memory cache (524).

The address comparison circuit (148) compares the write address and the read address to determine whether the two addresses access the same cache line. A determination that the two addresses access the same cache line is a determination that by the address comparison circuitry of the computer memory cache controller that the write data are to be written to and the read data are to be read from the same cache line. If the two addresses access the same cache line, as they do in this example, then the address comparison circuit signals the load memory instruction execution unit in which the load microinstruction is dispatched, by use of the stall output line (150), to stall the corresponding load microinstruction. That is, stalling the corresponding load microinstruction is carried out by signaling, by the address comparison circuit (148) through the stall output (150), the load memory instruction execution unit to stall the corresponding load microinstruction.

Stalling the corresponding load microinstruction typically delays execution of the corresponding load microinstruction (as well as all microinstructions pipelined behind the corresponding load microinstruction) for one processor clock cycle. So stalling the corresponding load microinstruction allows the execution engine to execute the second store microinstruction (116) after executing the first store microinstruction (112) while stalling the corresponding load microinstruction (114) without stalling the second store microinstruction (116). That is, although the corresponding load microinstruction suffers a stall, neither the first store microinstruction nor the second store microinstruction suffers a stall. The store microinstructions execute on immediately consecutive clock cycles, just as they would have done if the corresponding load microinstruction had not stalled.

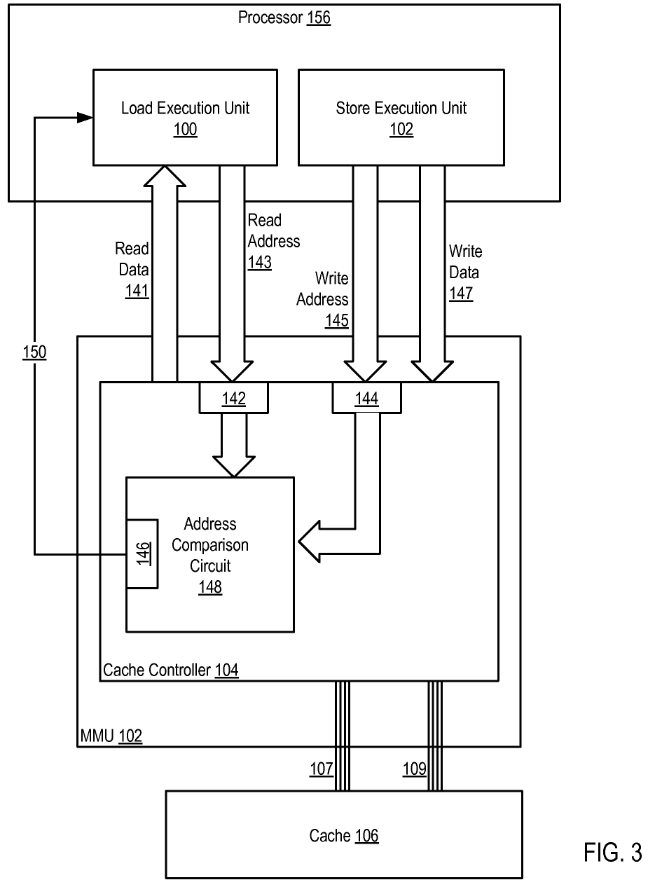

For further explanation, FIG. 3 sets forth a functional block diagram of exemplary apparatus for administering an access conflict in a computer memory cache according to embodiments of the present invention. The apparatus of FIG. 3 includes a superscalar computer processor (156), a load memory instruction execution unit (100), a store memory instruction execution unit (102), an MMU (102), a computer memory cache controller (104), an address comparison circuit (148), and a computer memory cache (106), all of which are configured to operate as described above in this specification.

In the example of FIG. 3, the computer memory cache controller (104) includes a load input address port (142). The load input address port (142) is composed of all the electrical interconnections, conductive pathways, bus connections, solder joints, vias, and the like, that are needed to communicate a read address (143) for a load microinstruction from the load memory instruction execution unit (100) to the cache controller (104) and to the address comparison circuit (148).

In the example of FIG. 3, the computer memory cache controller (104) includes a store input address port (144). The store input address port (144) is composed of all the electrical interconnections, conductive pathways, bus connections, solder joints, vias, and the like, that are needed to communicate a write address (145) for a store microinstruction from the store memory instruction execution unit (102) to the cache controller (104) and to the address comparison circuit (148).

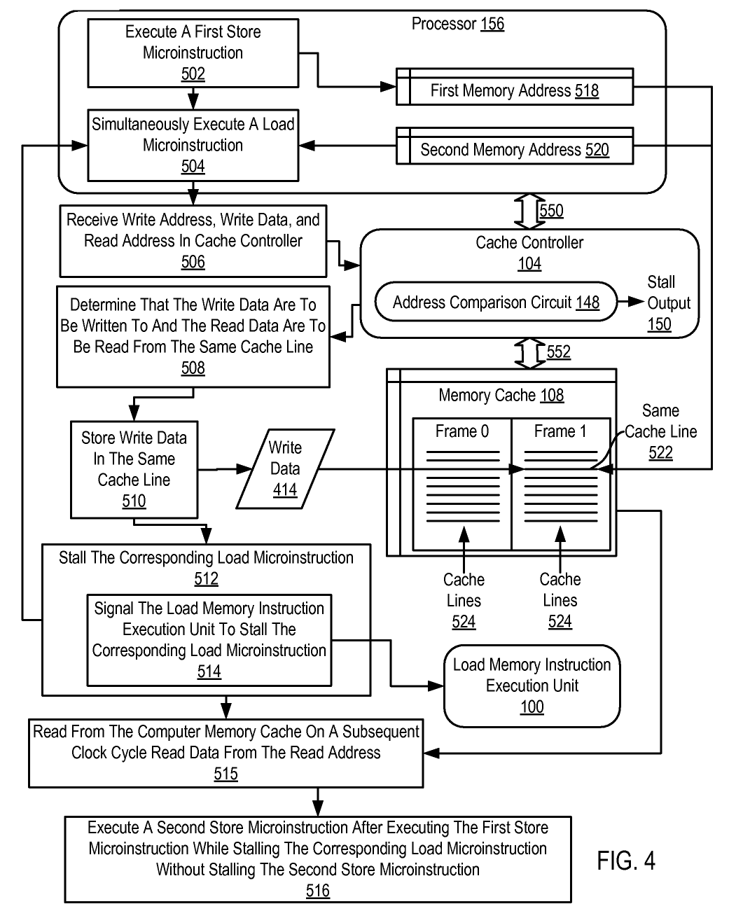

For further explanation, FIG. 4 sets forth a flow chart illustrating an exemplary method for administering an access conflict in a computer memory cache according to embodiments of the present invention. The method of FIG. 4 includes executing (502) in a store memory instruction execution unit of the superscalar computer processor (156) in a first pipeline a first store microinstruction to store write data in a write address (518) in computer memory. The write address in computer memory has contents that are cached in a same cache line (522) in a computer memory cache (108). The ‘same cache line’ refers to the same cache line from which a corresponding load microinstruction will load read data. The method of FIG. 4 also includes executing (504), simultaneously with executing the first store microinstruction, in a load memory instruction execution unit of the superscalar computer processor in a second pipeline, the corresponding load microinstruction to load read data from a read address (520) in computer memory. The read address in computer memory has contents that also are cached in the same cache line (522) in the computer memory cache (524). The cache memory (108) and the processor (156) are operatively coupled to one another through a computer memory cache controller (104).

In the method of FIG. 4, the computer memory cache (108) is configured as a set associative cache memory having a capacity of more than one frame (here, frames 0 and 1) of memory wherein a page of memory may be stored in any frame of the cache, and the write data to be written to and the read data to be read from a same cache line in the computer memory cache is implemented as the write data to be written to and the read data to be read from a same cache line in a same frame in the computer memory cache. That is, the fact that the write address (518) in computer memory has contents that are cached in the same cache line (522) in the computer memory cache means that the write address in computer memory has contents that are cached in the same cache line of the same frame (here, frame 1) in the computer memory cache (108). Similarly, the fact that the read address (520) in computer memory has contents that also are cached in the same cache line (522) in the computer memory cache means that the read address in computer memory has contents that also are cached in the same cache line of the same frame (frame 1) in the computer memory cache (108).

The method of FIG. 4 also includes receiving (506) in a memory cache controller a write address and write data from a store memory instruction execution unit of a superscalar computer processor and a read address for read data from a load memory instruction execution unit of the superscalar computer processor, for the write data to be written to and the read data to be read from a same cache line in the computer memory cache simultaneously on a current clock cycle. That is, the write data and the read data are dispatched, intended, to be written and read simultaneously. Whether this can be accomplished depends on whether the write data and the read data are to be written and read to and from the same cache line. If they are, then they cannot be written and read simultaneously.

The method of FIG. 4 also includes determining (508) by the address comparison circuitry of the computer memory cache controller that the write data are to be written to and the read data are to be read from the same cache line. In the method of FIG. 4, the computer memory cache controller (104) has an address comparison circuit (148) that has a stall output (150) for stalling the corresponding load microinstruction. Determining (508) that the write data are to be written to and the read data are to be read from the same cache line is carried out by the address comparison circuitry (148) of the computer memory cache controller (148). The fact that the write data are to be written to and the read data are to be read from the same cache line is an access conflict in the computer memory cache.

The method of FIG. 4 also includes storing (510) by the memory cache controller the write data in the same cache line on the current clock cycle. Having determined that an access conflict exists, the cache controller allows the first store microinstruction to complete its execution by storing the write data in the same cache line on the current clock cycle.

The method of FIG. 4 also includes stalling (512) the corresponding load microinstruction. Stalling (512) the corresponding load microinstruction in this example is carried out by signaling (514), by the address comparison circuit (148) through the stall output (150), the load memory instruction execution unit in the processor (156) to stall the corresponding load microinstruction.

The method of FIG. 4 also includes reading (515) by the memory cache controller (104) from the computer memory cache (108) on a subsequent clock cycle read data from the read address. The read address is in the same cache line (522).

In the method of FIG. 4, the superscalar computer processor includes a microinstruction queue (110 on FIG. 2) of the kind described above. The microinstruction queue contains the first store microinstruction, the corresponding load microinstruction, and a second store microinstruction, and the method of FIG. 4 includes executing (516) the second store microinstruction after executing the first store microinstruction while stalling the corresponding load microinstruction without stalling the second store microinstruction.

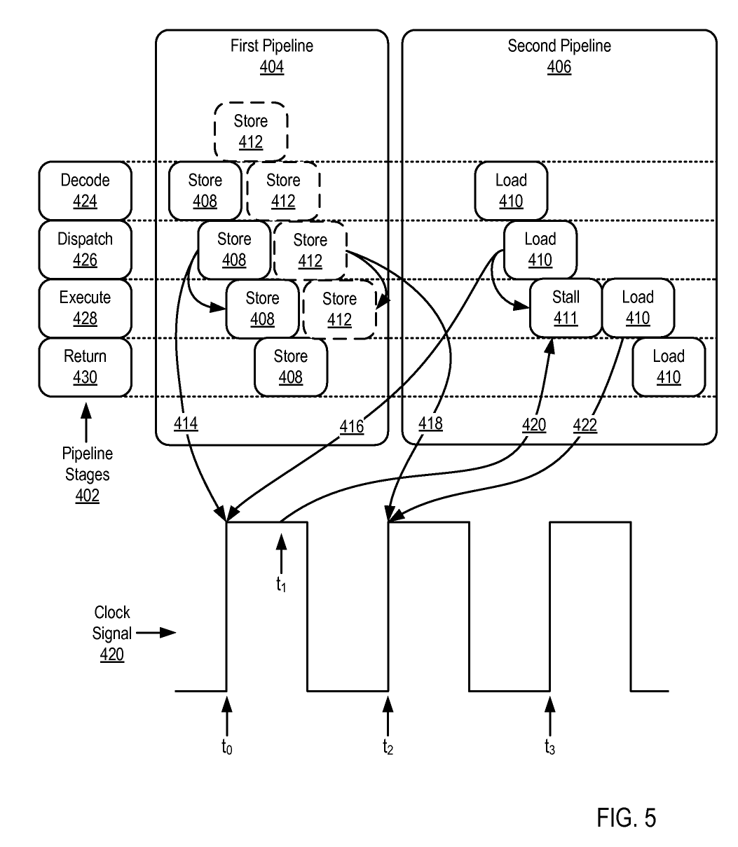

For further explanation, FIG. 5 sets forth an exemplary timing diagram that illustrates administering an access conflict in an computer memory cache according to embodiments of the present invention. The timing diagram of FIG. 5 illustrates a first store microinstruction (408) as it progresses through the pipeline stages (402) of a first pipeline (404). The timing diagram of FIG. 5 also illustrates a corresponding load microinstruction (410) as it progresses through the pipeline stages of a second pipeline (406). The timing diagram of FIG. 5 also illustrates a second store microinstruction (412) as it progresses through the pipeline stages of the first pipeline (404) just behind the first store microinstruction (408).

Although processor design does not necessarily require that each pipeline stage be executed in one processor clock cycle, it is assumed here for ease of explanation, that each of the pipeline stages in the example of FIG. 5 requires one clock cycle to complete the stage. The first store microinstruction and the corresponding load microinstruction enter the pipeline simultaneously, on the same clock cycle. They are both decoded (424) on the same clock cycle, and they are both dispatched (426) to execution units on the same clock cycle. They both enter the execution stage (428) on the same clock cycle, both attempting to execute (414, 416) on the same clock cycle at t₀. In the interval between t₀ and t₁, however, an address comparison circuit in a memory cache controller determines that both the first store microinstruction and the corresponding load microinstruction are attempting to access memory addresses in the same cache line. The circuitry of the computer memory cache is configured so that the cache can both load from cache memory and write to cache memory—so long as the simultaneous load and write are not directed to the same cache line.

In this example, therefore, the cache controller stalls the corresponding load microinstruction (420, 411) at time t₁. Stalling the corresponding load microinstruction delays execution of the corresponding load microinstruction (410) for one processor clock cycle. The corresponding load microinstruction (410) now executes (422) at time t₂. Stalling the corresponding load microinstruction allows the execution engine to execute (418) the second store microinstruction (412) immediately after executing the first store microinstruction (408) while stalling the corresponding load microinstruction (410) without stalling the second store microinstruction (412). That is, although the corresponding load microinstruction (410) suffers a stall, neither the first store microinstruction (408) nor the second store microinstruction (412) suffers a stall. The store microinstructions (408, 412) were dispatched for execution on the immediately consecutive clock cycles, t₀ and t₂, and the store microinstructions execute on the immediately consecutive clock cycles, t₀ and t₂, just as they would have done if the corresponding load microinstruction (410) had not stalled.

Exemplary embodiments of the present invention are described largely in the context of a fully functional computer system for administering an access conflict in a computer memory cache. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of administering an access conflict in a computer memory cache, the method comprising:
receiving in a memory cache controller a write address and write data from a store memory instruction execution unit of a superscalar computer processor and a read address for read data from a load memory instruction execution unit of the superscalar computer processor, for the write data to be written to and the read data to be read from a same cache line in the computer memory cache simultaneously on a current clock cycle;
storing by the memory cache controller the write data in the same cache line on the current clock cycle;
stalling, by the memory cache controller in the load memory instruction execution unit, a corresponding load microinstruction; and
reading by the memory cache controller from the computer memory cache on a subsequent clock cycle read data from the read address.

2. The method of claim 1 further comprising:
executing in the store memory instruction execution unit of the superscalar computer processor in a first pipeline a first store microinstruction to store write data in the write address in computer memory, the write address in computer memory having contents that are cached in the same cache line in a computer memory cache; and
executing, simultaneously with the executing of the first store microinstruction, in the load memory instruction execution unit of the superscalar computer processor in a second pipeline the corresponding load microinstruction to load read data from the read address in computer memory, the read address in computer memory having contents that also are cached in the same cache line in the computer memory cache.

3. The method of claim 1 wherein:
the computer memory cache is configured as a set associative cache memory having a capacity of more than one frame of memory wherein a page of memory may be stored in any frame of the cache; and
the write data to be written to and the read data to be read from a same cache line in the computer memory cache further comprises the write data to be written to and the read data to be read from a same cache line in a same frame in the computer memory cache.

4. The method of claim 1 wherein:
the computer memory cache controller comprises a load input address port, a store input address port, and an address comparison circuit connected to the load input address port, the address comparison circuit also connected to the store input address port, the address comparison circuit having a stall output connected to the load memory instruction execution unit for stalling the corresponding load microinstruction;
the method further comprises determining by the address comparison circuitry of the computer memory cache controller that the write data are to be written to and the read data are to be read from the same cache line; and
stalling a corresponding load microinstruction further comprises signaling, by the address comparison circuit through the stall output, the load memory instruction execution unit to stall the corresponding load microinstruction.

5. The method of claim 1 wherein:
the superscalar computer processor further comprises a microinstruction queue, the microinstruction queue containing the first store microinstruction, the corresponding load microinstruction, and a second store microinstruction; and
the method further comprises executing the second store microinstruction after executing the first store microinstruction while stalling the corresponding load microinstruction without stalling the second store microinstruction.

6. Apparatus for administering an access conflict in a computer memory cache, the apparatus comprising the computer memory cache, a computer memory cache controller, and a superscalar computer processor, the computer memory cache operatively coupled to the superscalar computer processor through the computer memory cache controller, the apparatus configured to be capable of:
receiving in the memory cache controller a write address and write data from a store memory instruction execution unit of the superscalar computer processor and a read address for read data from a load memory instruction execution unit of the superscalar computer processor, for the write data to be written to and the read data to be read from a same cache line in the computer memory cache simultaneously on a current clock cycle;
storing by the memory cache controller the write data in the same cache line on the current clock cycle;
stalling, by the memory cache controller in the load memory instruction execution unit, a corresponding load microinstruction; and
reading by the memory cache controller from the computer memory cache on a subsequent clock cycle read data from the read address.

7. The apparatus of claim 6 further configured to be capable of:
executing in the store memory instruction execution unit of the superscalar computer processor in a first pipeline a first store microinstruction to store write data in the write address in computer memory, the write address in computer memory having contents that are cached in the same cache line in a computer memory cache; and
executing, simultaneously with the executing of the first store microinstruction, in the load memory instruction execution unit of the superscalar computer processor in a second pipeline the corresponding load microinstruction to load read data from the read address in computer memory, the read address in computer memory having contents that also are cached in the same cache line in the computer memory cache.

8. The apparatus of claim 6 wherein:
the computer memory cache is configured as a set associative cache memory having a capacity of more than one frame of memory wherein a page of memory may be stored in any frame of the cache; and
the write data to be written to and the read data to be read from a same cache line in the computer memory cache further comprises the write data to be written to and the read data to be read from a same cache line in a same frame in the computer memory cache.

9. The apparatus of claim 6 wherein:
the computer memory cache controller comprises a load input address port, a store input address port, and an address comparison circuit connected to the load input address port, the address comparison circuit also connected to the store input address port, the address comparison circuit having a stall output connected to the load memory instruction execution unit for stalling the corresponding load microinstruction;
the apparatus is further configured to be capable of determining by the address comparison circuitry of the computer memory cache controller that the write data are to be written to and the read data are to be read from the same cache line; and
stalling a corresponding load microinstruction further comprises signaling, by the address comparison circuit through the stall output, the load memory instruction execution unit to stall the corresponding load microinstruction.

10. The apparatus of claim 6 wherein:
the superscalar computer processor further comprises a microinstruction queue, the microinstruction queue containing the first store microinstruction, the corresponding load microinstruction, and a second store microinstruction; and
the apparatus is further configured to be capable of executing the second store microinstruction after executing the first store microinstruction while stalling the corresponding load microinstruction without stalling the second store microinstruction.
